(19) United States
(12) Patent Application Publication
(10) Pub. No.: US 2007/0231557 A1
(43) Pub. Date: Oct. 4, 2007

(54) CAPTURE MEMBER AND INK JET PRINTER

(75) Inventor: Hidehiko Komatsu, Shiojiri-shi (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/695,698

(22) Filed: Apr. 3, 2007

(30) Foreign Application Priority Data
Apr. 3, 2006 (JP) 2006-101691

(51) Int. Cl. B41J 2/01; B32B 3/26

(52) U.S. Cl. 428/304.4; 428/320.2; 347/1

(57) ABSTRACT

A capture member for capturing ink droplets ejected onto a region other than the recording medium, wherein the ink droplets are of a nonaqueous ink composition, and are ejected from an ink jet recording head. The capture member includes a porous plastic produced by sinter molding plastic particles, and an oily solvent impregnated into the porous plastic.

### BACKGROUND

The entire disclosure of Japanese Patent Application No. 2006-101691, filed Apr. 3, 2006 is expressly incorporated herein by reference.

1. Technical Field

The present invention relates to a capture member and an ink jet printer. Particularly, present invention relates to a capture member capable of recapturing nonaqueous ink droplets and decreasing ink mist.

2. Related Art

Many ink-jet recording systems are capable of performing marginless printing, such as those used in silver salt photography. In marginless printing, it is necessary that the entire surface of the recording medium may be used as an image region with no need for a non-image region (margin). During marginless printing, ink droplets are continuously ejected from a printer head onto the surface of the medium, including the outside of the edge, so that a proper image is formed up to the edge.

In order to carry out marginless printing, the ink droplets are ejected outside the recording paper. In order to prevent the accumulation of ink droplets and staining the back side of the recording paper, systems typically include a capture member capable of absorbing and collecting the excess droplets. The capture member is usually made of a porous material (for example, a urethane foam). And typically, pigment-based inks are used, mainly because of their ability to improve the storage stability of printed matter. Unfortunately, however, in the pigment-based inks only a solvent component penetrates into the inside of the capture member, and pigment particles tend to remain and accumulate on the surface. The pigment particles gradually accumulate on the surface of the porous capture member, and eventually transfer the back side of different recording paper.

Several techniques for preventing the pigment accumulation of the aqueous inks have been proposed. For example, a technique of impregnating the capture member with an organic solvent has been proposed (Japanese Unexamined Patent Application Publication No. 2003-191545). Further, a technique of impregnating the capture member with an organic solvent corresponding to the kind of color of the pigment-based ink has also been proposed (Japanese Unexamined Patent Application Publication No. 2004-174978). In addition, a technique of using a two-layer structure in the capture member, including a receiving layer and a diffusion layer, or a multilayer structure of more layers have also been proposed (Japanese Unexamined Patent Application Publication No. 2003-39754). Finally, a technique of forming holes in the above-mentioned capture member in order to accelerate penetration has also been used (Japanese Unexamined Patent Application Publication No. 2004-1485).

In addition to these methods, marginless printing may be performed by not only an ink jet recording system using aqueous ink but also an ink jet recording system using nonaqueous ink. One advantage of using nonaqueous ink is that low-volatile solvents such as fatty acid hydrocarbons, glycol ethers, and higher alcohols, and relatively higher-volatile solvents such as methyl ethyl ketone and acetone may be used.

Despite these advantages, however, marginless printing using nonaqueous ink has specific problems different from that of printing using aqueous ink. For example, the urethane foam that is widely used as the material for the capture member in aqueous ink systems may be degraded by chemical attack by a solvent component contained in the nonaqueous ink. Furthermore, when the a highly-volatile solvent is used, ink tends to easily dry and accumulate on the surface of the capture member. In addition, ink mist often occurs, perhaps due to static electricity. This problem becomes even more significant as the ejection nozzle diameter is decreased in order to decrease the size of the ink droplets.

### SUMMARY

One aspect of the invention includes a capture member capable of securely recapturing ink droplets which have been ejected onto a region other than a recording medium and guiding the ink droplets to a waste liquid tank for use in an ink jet recording system marginless printing. The capture member of the invention is comprised of porous plastic produced by sinter molding plastic particles and an oily solvent impregnated into the porous plastic.

Another aspect of the invention is an ink jet printer including the above-described capture member. In the ink jet printer of the invention, the capture member is capable of capturing ink droplets which have been ejected to a region other than a recording medium. The ink droplets are then guided into a liquid waste tank.

In both configurations, the capture member is satisfactory stabile to chemical inversion of a component contained in nonaqueous ink (e.g., chemical resistance and organic solvent resistance). Thus, the capture member is not degraded by the component and is able to suppress the accumulation of the ink due and the occurrence of mist.

### BRIEF DESCRIPTION OF THE DRAWINGS

The invention will be described with reference to the accompanying drawings, wherein like numbers reference like elements.

FIGS. 1A to 1C are enlarged perspective views of a principal portion, each schematically showing a step of marginless printing by an ink jet recording system.

FIG. 2 is a schematic side view of a principal portion in the state shown in FIG. 1A.

FIG. 3 is a perspective view of a typical ink jet recording apparatus.

FIG. 4 is a partial plan view of a print mechanism portion of the ink jet recording apparatus shown in FIG. 3.

FIG. 5 is a partial sectional view of the print mechanism portion of the ink jet recording apparatus shown in FIG. 3.

### DESCRIPTION OF EXEMPLARY EMBODIMENTS

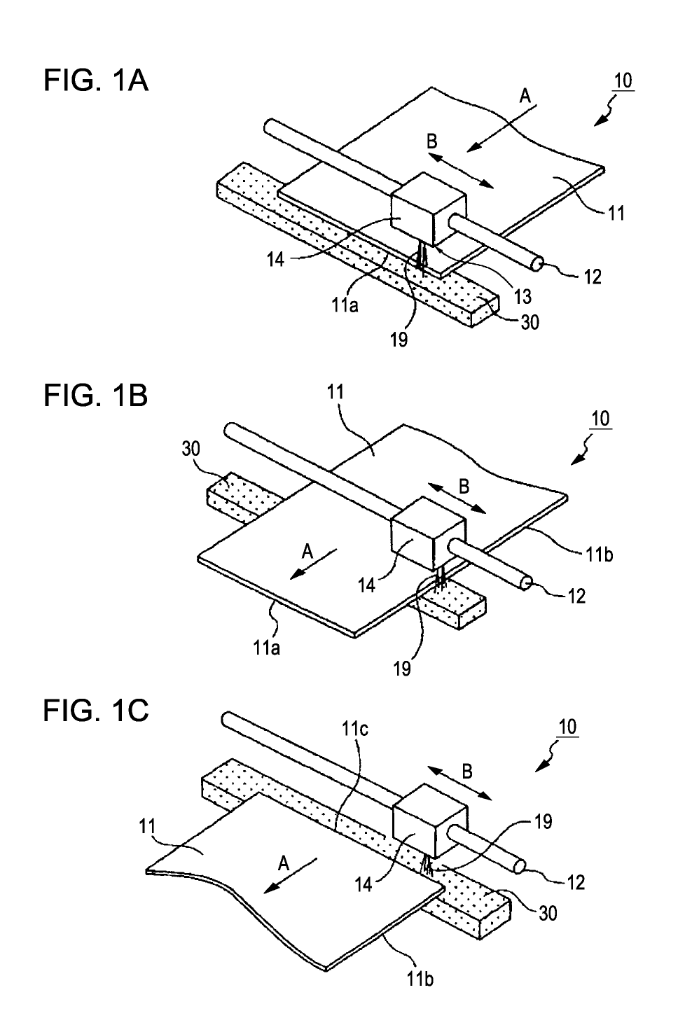

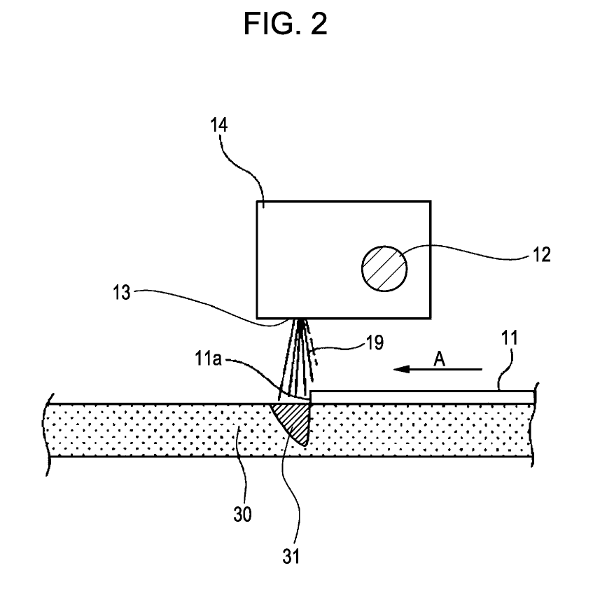

A method of marginless printing according to the present art will first be described with reference to FIGS. 1A to 1C and 2. FIGS. 1A to 1C are enlarged perspective views of a principal portion, which show the respective steps of marginless printing by an ink jet recording system. FIG. 1A shows printing on a leading edge portion of a recording medium, FIG. 1B shows printing on a side edge portion of a recording medium, and FIG. 1C shows printing on a trailing edge portion of a recording medium. FIG. 2 is a schematic side view of in the state shown in FIG. 1A.

As shown in FIGS. 1A to 1C and 2, an ink jet recording apparatus 10 includes a recording head 13 mounted on a carriage 14 which reciprocates along a guide shaft 12 extending in a main scanning direction (i.e., the width direction of recording paper 11; the direction shown by arrow B in FIGS. 1A to 1C), and a platen (not shown in the drawings) disposed below the recording head 13 so as to face the recording head 13. The recording paper 11 is transported between the recording head 13 and the platen by a paper feed unit (not shown in the drawings) in a sub-scanning direction (direction of arrow A in FIGS. 1A to 1C and 2).

When the leading edge portion 11a of the recording paper 11 is transported to a position below the recording head 13, the printing begins on the leading edge portion 11a. During this process, the recording head 13 ejects ink droplets 19 toward the recording paper 11 while reciprocating in the main scanning direction (direction of arrow B) along the guide shaft 12. In order to print without leaving a margin in the leading edge portion 11a of the recording paper 11, the ink droplets 19 are ejected beyond the leading edge portion 11a of the recording paper 11. The ink droplets 19 ejected outside area of the recording paper 11 adhere to a capture member 30 placed on the platen and later are collected in an ink capture region 31.

When printing on the leading edge portion 11a of the recording paper 11 is finished, the recording paper 11 is moved in the sub-scanning direction (direction of arrow A), and the center of the recording paper 11 is printed. In order to print the center without leaving a margin in both side edge portions lib of the recording paper 11, the ink droplets 19 are ejected beyond the side edge portions lib of the recording paper 11 as shown in FIG. 1B. The ink droplets 19 which are ejected outside the recording paper 11 adhere directly to the capture member 30 provided on the platen and are collected by the capture member 30.

When the central portion of the recording paper is printed, the recording paper 11 is transported in the sub-scanning direction (direction of arrow A), and the trailing edge portion lic of the recording paper 11 is printed. As previously described with the other edges of the paper, ink droplets 19 are ejected beyond the trailing edge portion lic and. These ink droplets 19 adhere directly to the capture member 30 provided on the platen and are captured by the capture member 30.

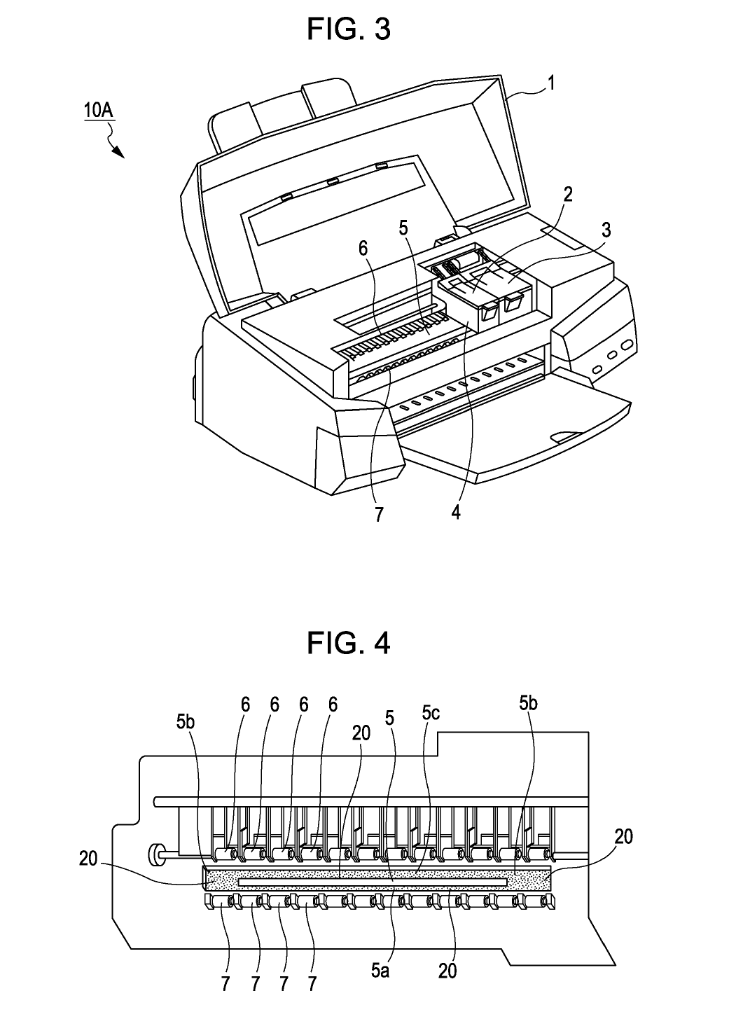

The capture member is preferably provided on the platen in order to prevent the back side of the recording paper 11 from being stained with the ink droplets 19 ejected outside the recording paper 11. FIGS. 3 to 5 show a typical ink jet recording apparatus including such a capture member.

FIG. 3 is a perspective view of a typical ink jet recording apparatus 10A and illustrates a printing mechanism with a case cover 1 opened. In the printing mechanism, there is a carriage 4 on which ink cartridges 2 and 3 and a recording head 4A are mounted and a platen 5 opposed to the movement path of the carriage 4. Across from the platen 5, are first paper pressing rollers 6, which are placed upstream from the discharging direction of the recording paper. Second paper pressing rollers 7 are disposed downstream.

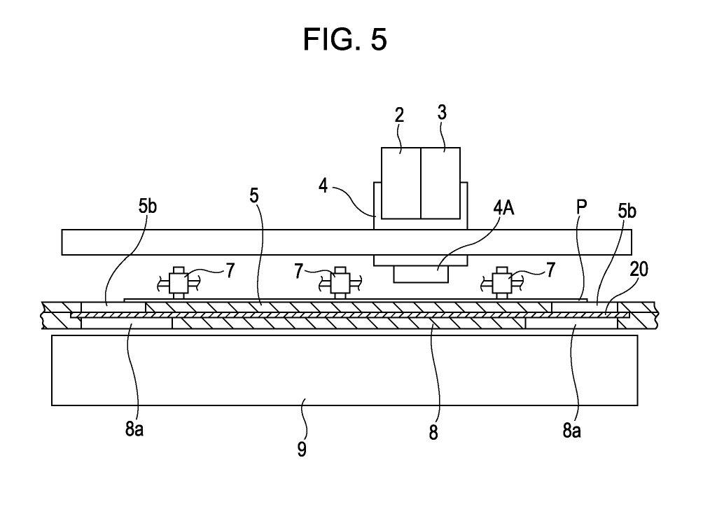

FIG. 4 is a partial plan view of the printing mechanism of the ink jet recording apparatus 10A shown in FIG. 3, and FIG. 5 is a partial sectional view of the printing mechanism shown in FIG. 3.

As shown in FIGS. 4 and 5, platen openings 5a, 5b, and 5c are provided in the platen 5, and a capture member 20 is disposed below the platen 5. The platen opening 5a is a window for allowing the ink droplets to adhere to the surface of the platen 5 and to be captured directly by the capture member 20 without producing ink mist while printing on a leading edge portion of recording paper P. Similarly, the platen openings 5b and 5c are windows used in printing on the side edge portions and the trailing edge portion of the recording paper P, respectively. In other words, the ink droplets ejected outside the recording paper P are directly captured by the capture member 20 through the platen openings 5a, 5b and 5c. The recording paper P is transported with its back side in contact with the surface of the platen 5. In this case, the capture member 20 is preferably disposed at such a height that the back side of the recording paper P does not come in contact with an upper surface of the capture member 20.

The capture member 20 is carried on a support member 8, as shown in FIG. 5, and a support member opening 8a is formed in the support member 8. A waste ink tank 9 is placed under this support member 8, so that any ink liquid temporarily captured by the capture member 20 is gradually transferred from the support member opening 8a to the waste ink tank 9, and absorbed and retained by an absorbing retainer, which is usually placed in the waste ink tank 9.

In this specification, the term “lower” or “upper” means lower or upper with respect to the gravitational direction while printing is performed by a printer.

A capture member according to one embodiment of the invention includes porous plastic produced by sinter-molding plastic particles. Thermoplastic particles may be used as the plastic particles. Examples of such plastic particles include particles of polyolefin resins (for example, polyethylenes such as ultra-high molecular weight polyethylene sand high-density polyethylenes, and polypropylenes), vinyl resins (for example, polyvinyl chloride resins), polyester resins (such as polyarylate) polyamide resins, polystyrene resins, acrylic resins, polysulfone resins, polyether sulfone resins, polyethylene sulfide resins, fluorocarbon resins, crosslinked polyolefin resins, and mixtures thereof.

Examples of the fluorocarbon resins include polytetrafluoroethylene, polyfluoroacryl acrylate, polyvinylidene fluoride, polyvinyl fluoride, and hexafluoropropylene.

A crosslinked polyolefin resin material is prepared by crosslinking a polyolefin resin (such as a polyethylene, including a low-density polyethylene, medium-density polyethylene, high-density polyethylene, or a polypropylene), by irradiation of ionizing radiation such as γ-rays or X-rays, or by chemical crosslinking using an inorganic compound as a crosslinking agent (such as aluminum chloride or nitrogen fluoride or an organic peroxide such as tert-butyl-cumyl peroxide, dicumyl peroxide, 2,5-dimethyl-2,5-di(tert-butylperoxy)hexane, or acetylene peroxide).

The average particle diameter of the plastic particles is not particularly limited, but is preferably 1,000 μm or less. In addition, the melt flow rate (MFR) is not particularly limited, but a material of MFR 0.01 or less is preferably used because it enables a sintered porous plastic having a uniform pore size.

The porous plastic used in the present invention can be produced by sinter molding the thermoplastic plastic particles, by a static molding method, or a dynamic molding method.

The static molding method may be a so-called in-mold sintering method, such as a method wherein a cavity formed in the space of a mold is filled with thermoplastic plastic particles, and then the plastic particles are heated together with the mold.

Among the dynamic molding methods, there are (1) ram extrusion method using a ram-type extruder including a piston (plunger) built to reciprocate in a temperature-controllable cylinder having a forming die at the tip thereof, (2) an injection molding method using an injection molding machine including a screw built in a temperature-controllable cylinder having a forming die at the tip thereof, (3) an extrusion molding method using an extrusion molding machine including a screw built in a temperature-controllable cylinder having a forming die at the tip thereof, (4) a compression molding method using a compression molding machine in which a cavity is formed in a female die portion of a forming die, wherein the male die is inserted into the inside diameter portion of the female die, filled with a raw material, and then heated, and (5) a continuous pressing methods wherein a raw material is extruded by a cylinder which has a forming die including upper and lower traveling belts or a lower traveling belt at a leading end.

From these static and dynamic methods, a proper method may be appropriately selected according to requirements for the final shape and physical properties of the porous plastic used in the invention.

The resulting molded product (molded plate) of the sintered porous plastic looks like an ordinary plastic molded product (molded plate) in appearance, but actually has numerous pores connected to each other in a plurality of directions. Further, the molded product of the sintered porous plastic is available commercially, and molded products (molded plates) having various pore sizes are readily available, such as those available from Porex Porous Plastic (Porex Technologies Inc.) and Fildus (Mitsubishi Plastics, Inc.).

The capture member of the invention contains the porous plastic and an oily solvent impregnated into the porous plastic. Preferably, the oily solvent is an oily solvent having a melting point of 10° C. or less and a boiling point of 150° C. The oily solvent may be a fatty acid hydrocarbon, a glycol ether, or a higher alcohol.

Examples of acceptable oily solvents include nonane (melting point −53° C., boiling point 150° C.), decane (melting point −30° C., boiling point 174° C.), dodecane (melting point −10° C., boiling point 216° C.), decalin (melting point −42° C., boiling point 195° C.), pentylbenzene (melting point −75° C., boiling point 205° C.), α-pinene (melting point −64° C., boiling point 156° C.), kerosene (melting point 0° C. or less, boiling point 180° C. to 330° C.), light oil (melting point 0° C. or less, boiling point 170° C. to 340° C.), spindle oil, machine oil, Isopar G (trade name, manufactured by Exxon Mobil Corporation) (melting point −57° C., boiling point 163° C. to 176° C.), Isopar H (melting point −63° C., boiling point 179° C. to 187° C.), Isopar L (melting point −57° C., boiling point 189° C. to 209° C.) (Isopar; Exxon Mobil Corporation trade name), mesitylene (melting point −44° C., boiling point 164° C.), tetralin (melting point −35° C., boiling point 207° C.), cumene (melting point −96° C., boiling point 152° C.), monools or polyols such as 3,5,5-trimethyl-1-hexanol (melting point −70° C. or less, boiling point 194° C.), 1-decanol (melting point 6° C., boiling point 232° C.), 1,3-propanediol (melting point −32° C., boiling point 214° C.), 1,3-butanediol (melting point −50° C. or less, melting point 208° C.), 1,5-pentanediol (melting point −16° C., boiling point 242° C.), hexyleneglycol (melting point −50° C. or less, boiling point 197° C.), octyleneglycol (melting point −40° C., boiling point 243° C.); cyclohexanone (melting point −45° C., boiling point 156° C.); benzyl acetate (melting point −52° C., boiling point 214° C.); 2-(benzyloxy)ethanol (melting point −25° C. or less, boiling point 256° C.); dipropylene glycol monomethyl ether (melting point −80° C., boiling point 190° C.); thiodiethanol (melting point −10° C., boiling point 282° C.); and diethylene glycol diethyl ether (melting point −44° C., boiling point 189° C.).

When the melting point is 10° C. or less, the oily solvent is a liquid within the operating temperatures of an ink jet recording apparatus, meaning that when the ink lands on a platen, it is in liquid form and readily flows from the capture member 20 into the ink tank 9. When the boiling point is 150° C. or more, the solvent rarely evaporates, meaning that the recovery process may be maintained over a long time.

When a capture member made of a polyurethane foam is impregnated with the diethylene glycol diethyl ether in order to project the capture member, the polyurethane foam swells causing a problem with the capture member contacting with recording paper. Advantageously, however, the porous plastic does not swell, thus the diethylene glycol diethyl ether may be used. Other examples of preferred diethylene glycol compounds include diethylene glycol; diethylene glycol ethers (particularly, alkyl ethers), such as diethylene glycol monomethyl ether, diethylene glycol dimethyl ether, diethylene glycol methylethyl ether, diethylene glycol monoethyl ether, diethylene glycol mono-n-butyl ether, and diethylene glycol di-n-butyl ether; and diethylene glycol esters such as diethylene glycol monoethyl ether acetate, diethylene glycol mono-n-butyl ether acetate, and diethylene glycol monoacetate. These oily solvents may be impregnated alone into the porous plastic or a mixture of two or more may be impregnated into the porous plastic.

The capture member may be imparted antistatic properties. An antistatic treatment may be performed by adding a conductive agent such as carbon black, carbon fibers, metal powder, or potassium titanate with surfaces coated with a metal into the thermoplastic particles in an amount of 1 to 5% by weight and preferably 1 to 2% by weight, and then sinter molding the resultant mixture. The antistatic treatment greatly suppresses the occurrence of mist due to static electricity.

The composition of the nonaqueous ink is not particularly limited, and any nonaqueous ink composition (oily ink composition) which has been used for an ink jet recording system may be satisfactorily captured by the capture member of the invention. Typically, the nonaqueous ink composition for ink jet recording includes a pigment, an organic solvent, and a dispersant.

Various inorganic pigments and organic pigments which are used for general aqueous ink compositions for ink jet recording may be used in accordance with the present invention. In particular, pigments having excellent solvent resistance are preferred. Examples useful as the pigment include the followings:

C. I. pigment yellow 16, 17, 83, 93, 94, 95, 97, 98, 108, 109, 110, 113, 117, 120, 128, 129, 133, 138, 139, 151, 153, 154, 155, 168, 169, 173, 180, 185, and 193;

C. I. pigment orange 16, 18, 19, 31, 34, 36, 42, 43, 51, 61, 63, and 71;

C. I. pigment red 48:1, 48:2, 48:3, 48:4, 52:1, 52:2, 57:1, 63:1, 63:2, 65, 66, 67, 68, 83, 88, 115, 122, 123, 133, 144, 146, 149, 150, 151, 166, 170, 171, 175, 176, 177, 178, 179, 185, 187, 189, 190, 194, 202, 208, 209, 214, 216, 220, 221, 224, 242, 243, 243:1, 246, and 247;

C. I. pigment blue 15:1, 15:2, 15:3, 15:4, 16, 60,

C. I. pigment violet 5:1, 19, 23, 31, and 32;

C. I. pigment green 7, 10, 12, and 36;

C. I. pigment brown 23, 25, and 32;

C. I. pigment black 1, 7; and

C. I. pigment white 1, 5, and 6.

Within the nonaqueous ink composition, the amount of the pigment used is preferably 0.5 to 30% by weight and more preferably about 1 to 10% by weight relative to the total weight of the nonaqueous ink composition. When the amount of the pigment used is excessively small, the color density of ink is decreased, and when the amount is excessively large, printing becomes difficult because of ink viscosity and fluidity.

The nonaqueous ink composition including an organic solvent may use any one of various organic solvents usable for general nonaqueous ink compositions for ink jet recording. For example, a saturated hydrocarbon solvent may be used.

Examples of the saturated hydrocarbon solvents include commercial saturated hydrocarbon solvents mainly used for general nonaqueous ink compositions in ink jet recording (particularly oily ink compositions), such as isoparaffin mixtures, e.g., Isopar E, Isopar G, Isopar H, Isopar L, and Isopar M (all manufactured by Exxon Mobil Corporation), Shellsol (manufactured by Shell Oil Company), Soltrol (manufactured by Phillips Petroleum Co., Ltd.), Begasol (manufactured by Mobil Petroleum Co., Ltd.), and IP Solvent 2835 (manufactured by Idemitsu Petrochemical Co., Ltd); and cycloparaffin mixtures, e.g., Exxsol D130 (manufactured by Exxon Chemical Co., Ltd.). Other examples include liquid paraffins each mainly composed of a mixture of the three components, i.e., normal paraffin, isoparaffin, and monocyclic cycloparaffin (including liquid paraffins referred to as “light liquid paraffins” in Japanese Pharmacopoeia), e.g., commercial products, such as Moresco White P-40 and Moresco White P-55 (manufactured by Matsumura Oil Research Corp.), and liquid paraffin No. 40-S and liquid paraffin No. 55-S (manufactured by Chuokasei Co., Ltd.).

Further organic solvents that may be used include normal paraffin hydrocarbons such as octane, nonane, decane, and dodecane; isoparaffin hydrocarbons such as isooctane, isodecane, and isododecane; and cycloparaffin hydrocarbons such as cyclohexane, cyclooctane, cyclodecane, and cyclododecane.

Among these saturated hydrocarbon solvents, a mixture of a cycloparaffin solvent having as high surface tension as possible and an isoparaffin solvent having a low melting point and a high boiling point is preferable, in order to improve ink ejection stability over a wide temperature range. When a combination of a cycloparaffin solvent and an isoparaffin solvent is used, the amounts of the cycloparaffin solvent and the isoparaffin solvent are preferably 20 to 70% by weight and 30 to 80% by weight, respectively, relative to the total amount of both solvents. In particular, a liquid paraffin is most preferred because it contains both components in a well-balanced state.

For the saturated hydrocarbon solvent, a solvent having a viscosity at 25° C. of 20 mPa·s or less is preferred in order to obtain optimal ink ejection stability. Also, a mixture of a low-viscosity saturated hydrocarbon solvent and a high-viscosity saturated hydrocarbon solvent may be used and controlled to have the above-described viscosity. Furthermore, in order to balance improvement in printing rate by evaporation drying against the clogging of nozzles, the boiling point of the saturated hydrocarbon solvent is preferably in the range of 180° C. to 360° C./760 mmHg. When a mixture of saturated hydrocarbon solvents is used, the boiling points of most of the components are in the above range.

In order to improve the solubility of the pigment dispersant, vegetable oil may be combined as an organic solvent. Examples of the vegetable oil include semidrying oil such as soybean oil, cottonseed oil, sunflower seed oil, rapeseed oil, mustard oil, sesame oil, and corn oil; non-drying oil such as olive oil, peanut oil, and camellia oil; and drying oil such as linseed oil and safflower oil. These vegetable oils may be used alone or as a mixture.

When a combination of a saturated hydrocarbon solvent and vegetable oil is used as the organic solvent, the ratio by weight of the saturated hydrocarbon solvent to the vegetable oil used is preferably in the range of 100:20 to 100:100, and more preferably 100:12 to 100:60. In addition, the total of the saturated hydrocarbon solvent and the vegetable oil in the organic solvent is preferably 70% by weight or more and more preferably 80% by weight or more.

In order to control the drying properties, boiling point, and viscosity of the nonaqueous ink composition to within a range in which surface tension is not decreased, the organic solvent may further contain an organic solvent which is miscible with the saturated hydrocarbon solvent, for example, a lower alcohol such as methanol, ethanol, or propanol, or an alkyl ether of (poly)alkylene glycol such as (poly)ethylene glycol or (poly)propylene glycol.

Various dispersants usable for general aqueous ink compositions for ink jet recording may be used. For example, various pigment dispersants and high-molecular-weight pigment dispersing resins, which are soluble in organic solvents, may be used.

Preferred examples of the pigment dispersant include reaction products of amine compounds and a self-condensation product of 12-hydroxystearic acid. Specific examples of such reaction products include the reaction product of polyallylamine and a self-condensation product of 12-hydroxystearic acid; the reaction product of polyethylenepolyamine and a self-condensation product of 12-hydroxystearic acid, e.g., a commercial product, Solsperse 13940, manufactured by Avecia Co., Ltd.; the reaction product of dialkylamino alkylamine and the self-condensation product of 12-hydroxystearic acid, e.g., commercial products, Solsperse 17000 and 18000, manufactured by Avecia Co., Ltd.

Other examples of the pigment dispersant include long-chain alkylamine acetate compounds such as octadodecylamine acetate; quaternary ammonium salts such as alkyl (hardened beef tallow) triethylammonium chloride; polyoxyethylene derivatives such as polyoxyethylene monostearate; sorbitan ester compounds of long-chain fatty acids such as sorbitan monooleate, sorbitan monolaurate, and sorbitan monostearate; and commercial products such as pigment derivative Solsperse 5000 manufactured by Avecia Co., Ltd., polyamine compound EFKA47 (manufactured by EFKA Chemicals Co., Ltd.), and polyester polymer compound Hinoact KF1-M and T-7000 (manufactured by Takefu Fine Chemicals Co., Ltd.).

Examples of the pigment dispersing resin include petroleum resins, rosin-modified maleic acid resins, rosin-modified phenol resins, alkylphenol resins, alkyd resins, aminoalkyd resins, acrylic resins, polyamide resins, and cumarone-indene resins.

The amount of the dispersant used is preferably 0.1 to 10 times by weight the amount of the pigment used.

In order to improve adhesion to a printing material, any one of various binder resins used for general nonaqueous ink compositions for ink jet recording may be used. In addition, various additives such as a surfactant, a viscosity adjustor, a defoaming agent, and a film formation auxiliary may be added.

The viscosity of the nonaqueous ink composition is, for example, 1.0 to 30.0 Pa·s and is more preferably 3.0 to 10.0 Pa·s at the ambient temperature during use. When the viscosity is within this range, the ejection stability in high-speed printing and penetration into the capture member are improved. The surface tension of the nonaqueous ink composition is preferably between 20 to 30 mN/m at 25° C.

The sintered porous plastic constituting the capture member is capable of not only rapidly directing the ink droplets landed on the surface in the inward direction (gravitational direction) from the surface but also diffusing the ink droplets in the lateral direction (horizontal direction) of the surface. This property means that the capture member is preferably used in color printers wherein ink droplets do not land on the previous ink droplets that have landed on the surface of the capture member.

In marginless printers of the current art, when an ink droplet lands on the surface of the capture member the ink droplet components travel into the capture member, often leaving a residue. The residue may be absorbed by the capture member by another ink droplet landing on the residue ink droplets. However, in many color printers, the printer head has a structure in which another ink droplet may not landed on the ink droplet residue, and the capture member have low dispersion properties in the horizontal direction, meaning that the ink components remaining on the surface of the capture member have no opportunity to penetrate into the capture member, and tends to dry and solidify on the capture member.

One advantage of the sintered porous plastic capture member according to an embodiment of the invention is the ability to diffuse the ink components in the horizontal direction. Therefore, even in a printer including a printer head for color printing, the drying and solidification of ink droplet residue on the surface of the capture member may be effectively decreased.

### EXAMPLES

Although the present invention will be descried in detail below with reference to examples, the scope of the invention is not limited by the examples.

### Examples 1

### (1) Preparation of Capture Member

The cavity of a forming die having a rectangular sectional shape was filled with ultra-high molecular weight polyethylene having an average particle diameter of 160 μm and a melt flow rate (MFR) of 0.01 or less so that the layer thickness ratio was 70% of the total thickness of a final filter, followed by heating at a temperature of 160° C. to 220° C. for 30 minutes to obtain a large-particle porous material with a large pore size.

The large-particle porous material was uniformly impregnated with 3,5,5-trimethyl-1-hexanol (melting point=−70° C. or less; boiling point=194° C.) as an oily solvent so that the coating amount was 200 g/m₂ to prepare a capture member of this example.

### (2) Production of Black Ink Composition

Solsperse 17000 (3 parts) serving as a dispersant was dissolved in liquid paraffin No. 40-S (12 parts), and 5 parts of carbon black MA-7 (manufactured by Mitsubishi Chemical Co., Ltd.) used as a pigment was mixed with the resultant solution by stirring and then dispersed using an Eiger mill to obtain a black dispersion liquid.

Next, liquid paraffin No. 40-S (40 parts) and Isopar M (45 parts) were added to the resulting black dispersion liquid (15 parts), and the mixture was stirred to obtain a black ink composition. Isopar M is an isoparaffin mixture (manufactured by Exxon Chemical Company).

### (3) Evaluation of Physical Properties

The capture member prepared as described above in (1) and the black ink composition prepared as described above in (2) were set in an ink jet printer (PX-V600: manufactured by Seiko Epson Corporation), and marginless printing was carried out on 500 sheets of postcard paper in an environment of 40° C. and relative humidity 20%.

As a result of the printing process, the pigment was not accumulated on the surface of the capture member and was satisfactorily absorbed into the capture member. After the printing was completed, the capture member was removed from the printer and observed. Neither deformation nor deterioration was observed, and it was thus confirmed that the capture member has excellent durability. In addition, no staining due to mist was not observed in any of the sheets of postcard paper.

### Example 2

### (1) Preparation of Capture Member

A porous material with a smaller pore size than in Example 1 was prepared by the same method as in Example 1 except that ultra-high molecular weight polyethylene having an average particle diameter of 50 μm was used.

The porous material was uniformly impregnated with diethylene glycol diethyl ether (melting point=−44° C.; boiling point=189° C.) as an oily solvent so that the coating amount was 200 g/m² to prepare a capture member of this example.

### (2) Production of Yellow Ink Composition

Hinoact KF1-M (8 parts) serving as a dispersant was dissolved in 50 parts of diethylene glycol diethyl ether, and 20 parts of C. I. pigment yellow 97 used as a pigment and 2 parts of Solsperse 5000 (manufactured by Avecia Co., Ltd.) were mixed with the resultant solution by stirring and then dispersed using an Eiger mill to obtain a yellow dispersion liquid.

Next, 25 parts of dipropylene glycol monomethyl ether and 25 parts of diethylene glycol diethyl ether were added to 50 parts of the resulting yellow dispersion liquid, and the mixture was stirred to obtain a yellow ink composition.

### (3) Production of Magenta Ink Composition

A magenta ink composition was produced by the same method as that for producing the yellow ink composition (2) except that C. I. pigment red 122 was used as a pigment.

### (4) Production of Cyan Ink Composition

A cyan ink composition was produced by the same method as that for producing the yellow ink composition (2) except that C. I. pigment blue 16 was used as a pigment.

### (5) Evaluation of Physical Properties

The capture member prepared as described above in (1) and the ink compositions prepared as described above in (2) to (4) were set in an ink jet printer (PX-V600: manufactured by Seiko Epson Corporation), and marginless printing was carried out on 500 sheets of postcard paper in an environment of 40° C. and relative humidity 20%.

During the printing, no pigment was accumulated on the surface of the capture member, and the pigment was satisfactorily penetrated into the capture member. After the printing completed, the capture member was removed from the printer and observed. Neither deformation nor deterioration were observed, and it was thus confirmed that the capture member has excellent durability. In addition, no staining due to mist was not observed in any of the sheets of postcard paper.

What is claimed is:

1. A capture member capable of capturing ink droplets which have been ejected onto a region other than a recording medium, wherein the ink droplets are of a nonaqueous ink composition and are ejected from an ink jet recording head, the capture member comprising:
a porous plastic produced by sinter molding plastic particles; and
an oily solvent which has been impregnated into the porous plastic.

2. The capture member according to claim 1, wherein the plastic particles are particles of a polyolefin resin, a vinyl resin, a polyester resin, a polyamide resin, a polystyrene resin, an acrylic resin, a polysulfone resin, a polyether sulfone resin, a polyethylene sulfide resin, a fluorocarbon resin, a crosslinked polyolefin resin, or a mixture thereof.

3. The capture member according to claim 1, wherein the oily solvent is an oily solvent or a mixture of two or more oily solvents having a melting point of 10° C. or less and a boiling point of 150° C. or more.

4. The capture member according to claim 3, wherein the oily solvent is a diethylene glycol compound.

5. The capture member according to claim 4, wherein the diethylene glycol compound is diethylene glycol diethyl ether.

6. The capture member according to claim 1, wherein the nonaqueous ink composition is a nonaqueous pigment-based ink composition.

7. The capture member according to claim 1, wherein the nonaqueous ink composition contains a saturated hydrocarbon solvent.

8. The capture member according to claim 7, wherein the saturated hydrocarbon solvent is a liquid paraffin.

9. An ink jet printer comprising the capture member according to claim 1.

10. An ink jet printer comprising:
a ink jet recording head capable of ejecting ink droplets of a nonaqueous ink composition onto a recording medium; and
a capture member capable of capturing the ink droplets which have been ejected onto a region other than the recording medium, comprising:
a porous plastic produced by sinter molding plastic particles; and
an oily solvent which has been impregnated into the porous plastic.

11. The ink jet printer according to claim 10, wherein the plastic particles of the capture member are particles of a polyolefin resin, a vinyl resin, a polyester resin, a polyamide resin, a polystyrene resin, an acrylic resin, a polysulfone resin, a polyether sulfone resin, a polyethylene sulfide resin, a fluorocarbon resin, a crosslinked polyolefin resin, or a mixture thereof.

12. The ink jet printer according to claim 10, wherein the oily solvent of the capture member is an oily solvent or a mixture of two or more oily solvents having a melting point of 10° C. or less and a boiling point of 150° C. or more.

13. The ink jet printer according to claim 12, wherein the oily solvent of the capture member is a diethylene glycol compound.

14. The ink jet printer according to claim 13, wherein the diethylene glycol compound of the capture member is diethylene glycol diethyl ether.

15. The ink jet printer according to claim 10, wherein the nonaqueous ink composition is a nonaqueous pigment-based ink composition.

16. The ink jet printer according to claim 10, wherein the nonaqueous ink composition contains a saturated hydrocarbon solvent.

17. The ink jet printer according to claim 16, wherein the saturated hydrocarbon solvent is a liquid paraffin.
